(19) United States
(12) Patent Application Publication
(10) Pub. No.: US 2010/0115429 A1
(43) Pub. Date: May 6, 2010

(54) SYSTEM FOR SELECTING AND PLAYING A USER-SPECIFIED CONTENT WITHIN A WINDOW OF A WEB BROWSER AND PROGRAMS THEREFOR

(75) Inventors: Kouji Ohura, Shibuya-ku (JP); Takayuki Matsuzawa, Shibuya-ku (JP); Hirochika Matsuo, Shibuya-ku (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: ants Inc., Shibuya-ku, Tokyo (JP)

(21) Appl. No.: 12/522,083

(22) PCT Filed: Dec. 27, 2007
(86) PCT No.: PCT/JP2007/001482

§ 371 Date: Jul. 2, 2009

(30) Foreign Application Priority Data
Jan. 5, 2007 (JP) 2007-000808

(51) Int. Cl. G06F 3/01

(52) U.S. Cl. 715/760; 715/781

(57) ABSTRACT

A system comprising a processor, a local storage storing a user profile, a content selector program executable by the processor, and a selection condition sender program executable by the processor. The content selector program is a predetermined file playable by a specific plug-in on a web browser and selects one of contents in accordance with a selection condition to display the selected content within a window of the web browser. The selection condition sender program is cooperable with the content selector program played by the specific plug-in, obtains the user profile from the local storage and sends the played content selector program the selection condition on the basis of the user profile data so as to lead the played content selector program to display the selected content in accordance with the user profile.

### TECHNICAL FIELD

This invention relates to a system for selecting one of contents on the basis of a user profile data and displaying the selected content within a window of a web browser, and to programs therefor.

### BACKGROUND ART

Generally, target-specified or customer-specified advertisements may achieve a high advertising effectiveness as compared with non-specified advertisements such as advertisements for all people. For example, an advertisement that has contents selected on the basis of the age or the gender of a user is more effective for the user. Therefore, various methods and systems have been proposed in order to provide the target-specified advertisement. An example of the foregoing technique is disclosed in EP 0 887 743 A1, which is incorporated herein by reference.

The recent web browsers have functions extended by means of various plug-ins therefor, such as a Flash Player®, and are enabled to express more visual contents other than contents consisting of texts and still images. Advertisements with the improved expressiveness on a web browser have a high possibility that users are interested therein. If such plug-in based advertisements are target-specified, they have more effective, as mentioned above. Therefore, there is a need, especially by the business organizations, to use the improved expressiveness based on various plug-ins to provide target-specified advertisements on a user's web browser upon the user visits their internet site by his/her web browser.

### DISCLOSURE OF INVENTION

One of known techniques for providing target-specified or personalized advertisement is to use cookie data. However, common use of cookie data over different domains is normally allowed and, even if it is allowed, is not preferable in system-security aspects. In order to use cookie data appropriately, target-specified advertisements based on suitably-used plug-ins should ask a user to input his/her information for every site. Such a user-imposed system will not be accepted by the user.

It is an object of the present invention to provide a system for selecting a content personalized for a user and displaying the selected content within a window of a web browser on his/her computer system.

One of plug-ins for web browsers such as Flash® plug-in is preliminarily implemented with a technique to realize an inter-file communication on a local machine such as “Local Connection.” By using the inter-file communication such as “Local Connection”, the present invention send a user profile data stored in a local storage to a file played by a plug-in to change, to a user-specified content, a content provided by the file played by the plug-in.

According to one aspect of the present invention, a system comprises a processor, a local storage storing a user profile, a content selector program executable by the processor, and a selection condition sender program executable by the processor. The content selector program is a predetermined file playable by a specific plug-in on a web browser and selects one of contents in accordance with a selection condition to display the selected content within a window of the web browser. The selection condition sender program is cooperable with the content selector program played by the specific plug-in, obtains the user profile from the local storage and sends the played content selector program the selection condition on the basis of the user profile data so as to lead the played content selector program to display the selected content in accordance with the user profile.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a block diagram schematically showing a typical computer system in accordance with an embodiment of the present invention;

FIG. 2 is a diagram schematically showing a system for selecting and displaying a content within a window of a web browser according to an embodiment of the present invention.

FIG. 3 is a flowchart schematically showing a communication between an swf file and a gadget for displaying a user-specified content according to an embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### BEST MODE FOR CARRYING OUT THE INVENTION

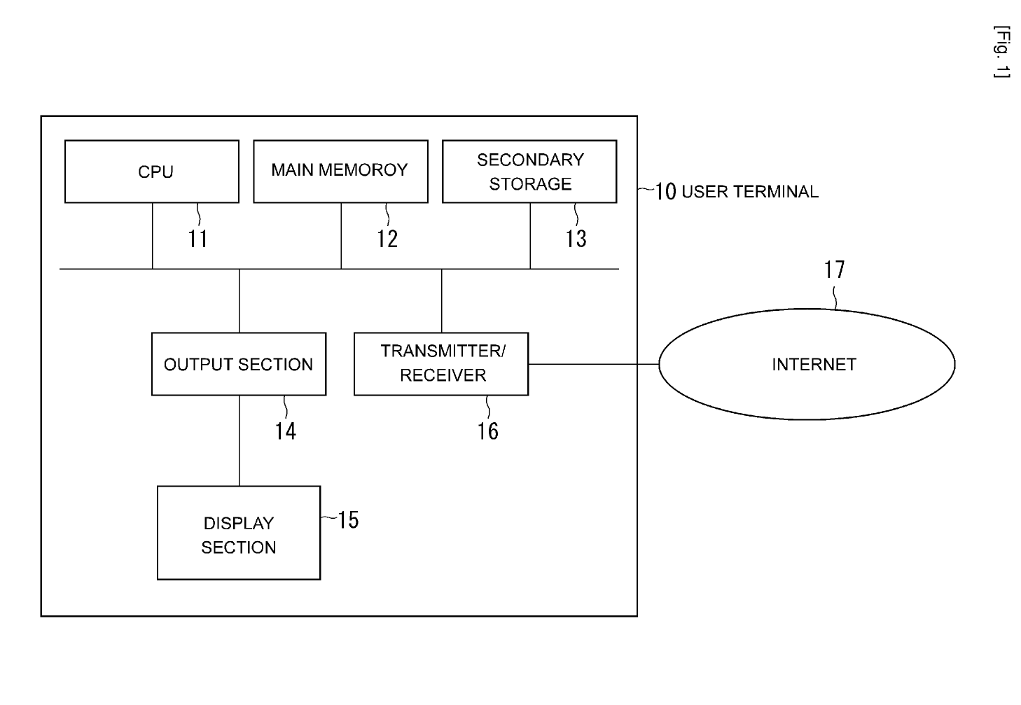

With reference to FIG. 1, a user terminal 10 comprises a CPU 11, a main memory 12, a secondary storage 13, an output section 14, and a transmitter/receiver 16 which are connected to each other via a bus. The user terminal 10 also comprises a display section 15 connected to the output section 14. The main memory 12 comprises, for example, a dynamic access random memory (DRAM). The secondary storage 13 comprises, for example, a hard disk drive (HDD). The display section 15 comprises a display unit such as a liquid crystal display (LCD) unit or the like.

Programs according to an embodiment of the present invention are stored in the secondary storage 13. The programs are loaded on the main memory 12 and are executed by the CPU 11. The main memory 12 also stores, but temporarily, data generated during the operation of the CPU 11 or data to be used by the CPU 11.

The transmitter/receiver 16 establishes a connection between the user terminal 10 and the Internet 17 under the control of the CPU 11. As a result of the prescribed process, an image and so on is displayed on the display section 15 via the output section 14.

The programs according to the present embodiment are read and executed by the CPU 11. As the result, the following operations will carried out.

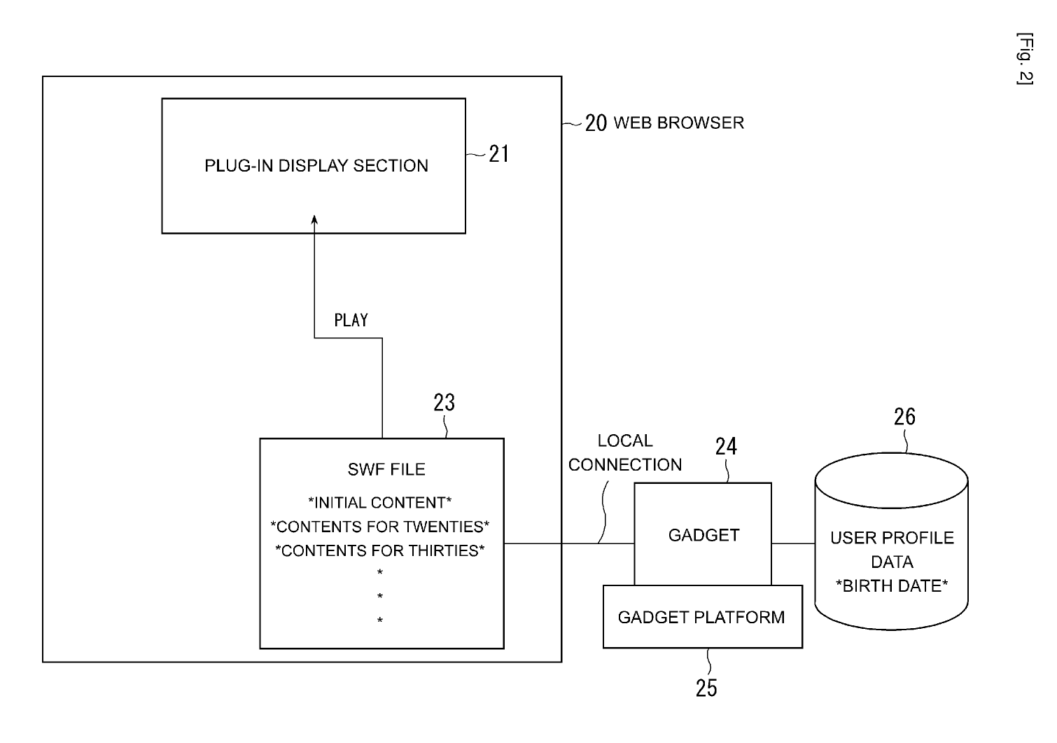

With reference to FIG. 2, a web browser 20 is displayed on the display section 15. The web browser 20 reads an html file which includes an URL of an swf file. Then the web browser 20 downloads the swf file according to the statements included in the html file and displays the same on the web browser 20.

An swf file is a file playable by a Flash Player®. When an swf file is played by the Flash Player®, the played swf file is displayed within a plug-in display area 21 of the web browser 20.

Note here that an swf file is a kind of a program which contains one or more contents to be displayed and control commands for controlling how to display the contents. Contents may include still images, movies or sound files, and the behavior of the contents may be controlled by control commands included in the swf file that contains the contents. For example, contents to be played are changed in accordance with branch instructions.

When being played by the Flash Player®, an swf file 23 according to the present embodiment serves as a content selector program for selecting one of contents to be displayed on the basis of a selection condition.

A gadget 24 is an application which is operative on a particular gadget platform 25 and is cooperable with the swf file 23 via the Local Connection. Available gadget platform 25 is for example “GIZMO” provided by the ants Inc., for more information about “GIZMO”, visit their web site: http://www.anthill.jp/en/

The gadget 24 of this embodiment serves as a selection condition sender program for sending the selection condition to the swf file 23 so as to lead the swf file 23 select the content based on the selection condition. The selection condition is based on a user profile data which is preliminarily stored in a local storage 26, i.e. the secondary storage 13. The gadget 24 of the present embodiment is visually-transparent because there is no need to be visible from the user. However, the gadget may be visible.

The user profile data 26 includes, for example, the user's birth date or the user's gender. In this embodiment, the user profile data 26 is inputted by the user at the time of installing the gadget platform 25 and is stored in the local storage 26. As may be understood from the following description, the user profile data 26 may be updated at the appropriate timing.

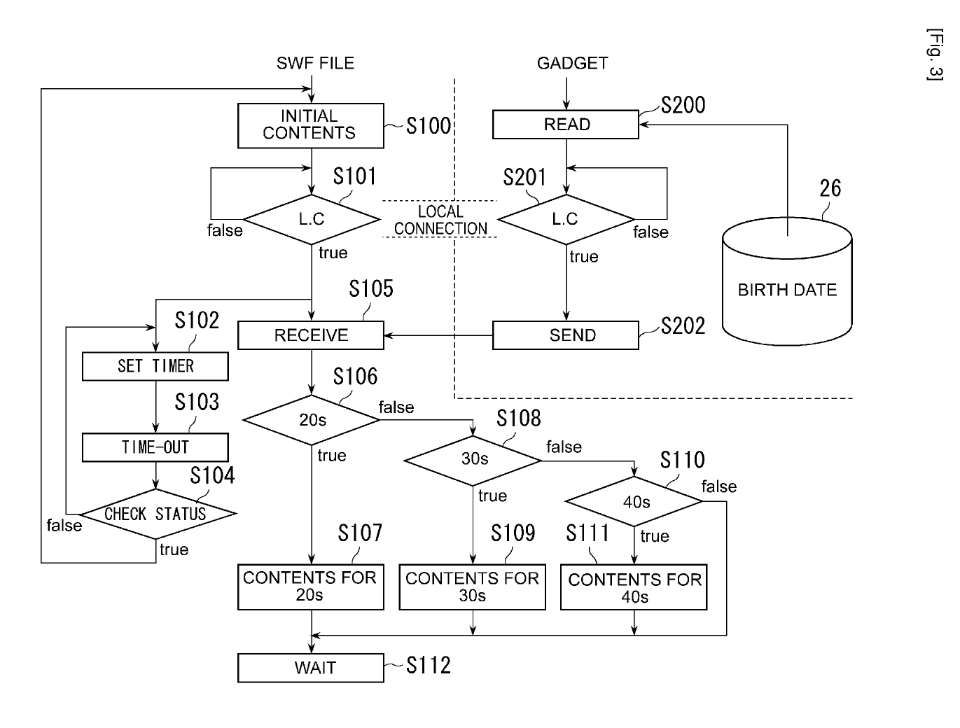

With reference to FIG. 3, the gadget 24 on the gadget platform 25 cooperates with the swf file 23 played by the Flash Player®.

When the swf file 23 is played by the Flash Player®, an initial content is displayed within the plug-in display area 21 of the web browser 20 (S100). Then the swf file 23 searches for a partner for the Local Connection (S101). Unless the Local Connection is established, the swf file 23 keeps displaying the initial content.

The gadget 24 reads the birth date of the user from the user profile data 26 (S200) and searches for a partner for the Local Connection (S201), too.

The Local Connection is established when the swf file 23 and the gadget 24 recognize each other as connection partners. After the Local Connection is established, the swf file 23 sets a timer (S102) and await the reception of the selection condition. The gadget 24 sends the swf file 23 the birth date data of the user as the selection condition (S202).

When receiving the birth date from the gadget 24 (S105), the swf file 23 judges the age of the user and displays the content that is specified for the user (S106-S111).

For example, if the birth date of the user profile date 26 is Oct. 16, 1982, the gadget 24 sends the swf file 23 the user profile data 26 indicating “Oct. 16, 1982” as the selection condition. Upon receiving the selection condition, the swf file 23 judges whether the user is twentysomething, i.e. whether the user is older than nineteen but younger than thirty (S 106) and, if it is judged as “true”, then displays the content appropriate for the twentysomething user (S107) and turns in a waiting state (S112). When the received selection condition indicates that the user is thirtysomething (S108), the swf file 23 displays the content appropriate for the thirtysomething user (S109) and turns in the waiting state (S112). Similarly, when the received selection condition indicates that the user is fortysomething (S110), the swf file 23 displays the content appropriate for the fortysomething user (S111) and turns in the waiting state (S112). In case where the received selection condition does not match any of the generations as mentioned above, the swf file 23 does not change the content from the initial content.

When the timer which was set at the step S102 becomes time-out (S103), the swf file 23 checks whether the gadget 24 is closed or not (S104). When the gadget 24 is not closed, the swf file 23 again sets the timer (S102) and keeps periodically checking the status of the gadget 24. When the gadget 24 is closed, the swf file 23 returns to the step S100 so that the swf file 23 displays the initial content (S100) and searches for new partner for the Local Connection (S101). In this embodiment, the checking the status of the gadget 24 has priority over the selection of the contents (S106-S112). For example, when the gadget 24 is closed after the content for the twentysomething user is displayed (S107), the swf file 24 changes the content for the twentysomething user to the initial content (S100).

The gadget 24 may be configured so that the gadget 24 closes the Local Connection when the user profile data 26 is updated while the swf file 23 displays the content selected in accordance with the selection condition. The configured gadget enables the swf file 23 to always provide the content matched with the updated profile. In detail, since the configured gadget closes the Local Connection upon the update of the user profile data, the result of the judgment always be “false” at the step S104, and the displayed content is then changed to the initial content (S100). After the completion of the update of the user profile data, the gadget 24 reads the updated user profile data 26 (S200). After the Local Connection is re-established, the gadget 24 sends the swf file 23 new selection condition in accordance with the updated user profile data 26 (S202). The swf file 23 displays the content appropriate for the received new selection condition.

As apparent from FIG. 3, no existence of the executed gadget 24 results in that the user-specified content is not displayed. In other words, only the initial content will be displayed.

Although the swf file 23 includes a plurality of contents and selects the appropriate one of the contents based on the user profile data in the above-described embodiment, the present invention is not limited thereto. The swf file 23 may have no contents. In that case, the web browser 20 download the appropriate content in accordance with the judgment result of the swf file 23 based on the user profile data 26.

The present application is based on Japanese patent applications of JP2007-000808 filed before the Japan Patent Office on Jan. 5, 2007, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

1. A system comprising a processor, a local storage storing a user profile, a content selector program executable by the processor, and a selection condition sender program executable by the processor, wherein:
the content selector program is a predetermined file playable by a specific plug-in on a web browser and selects one of contents in accordance with a selection condition to display the selected content within a window of the web browser; and
the selection condition sender program is cooperable with the content selector program played by the specific plug-in, obtains the user profile data from the local storage and sends the played content selector program the selection condition on the basis of the user profile data so as to lead the played content selector program to display the selected content in accordance with the user profile.

2. The system according to claim 1, wherein the specific plug-in is a Flash Player® and the predetermined file is an swf file.

3. The system according to claim 1, wherein the content selector program is obtained through a network, the content selector program containing the contents, the content selector program comprising:
establishing a local connection between the selection condition information program;
receiving the selection condition from the selection condition information program via the local connection; and
selecting and displaying one of the contents in accordance with the received selection condition without further receiving the data for the selected content through the network.

4. The system according to claim 1, wherein the content selector program contains an initial content, the content selector program comprising:
displaying the initial content until the content selector program receives the selection condition;
receiving the selection condition from the selection condition sender program;
selecting and displaying one of the contents in accordance with the received selection condition;
periodically checking whether the selection condition information program is closed; and
if the selection condition information program is closed, changing the displayed content from the selected content to the initial content.

5. The system according to claim 1, wherein the selection condition sender program is operative as a gadget on a particular gadget platform.

6. The system according to claim 5, wherein the user profile data is input by a user at the time of installing the particular gadget platform and stored in the local storage.

7. The system according to claim 1, wherein the selection condition information program comprises:
establishing the local connection with the content selection program; and
sending the selection condition based on the user profile data to the content selector program via the local connection.

8. The system according to claim 7, wherein the selection condition sender program further comprises:
reading the user profile data from the local storage before establishing the local connection; and
generating the selection condition on the basis of the user profile data.

9. The content selection program according to claim 1.

10. The selection condition information program according to claim 1.
